(19) United States
(12) Patent Application Publication
(10) Pub. No.: US 2013/0153795 A1
(43) Pub. Date: Jun. 20, 2013

(54) BODY SHIELD FOR THERMAL AND ELECTRICAL RADIATION

(71) Applicant: Daniel T. DeBaun, Bradenton Beach, FL (US)

(72) Inventor: Daniel T. DeBaun, Bradenton Beach, FL (US)

(21) Appl. No.: 13/709,875

(22) Filed: Dec. 10, 2012

Related U.S. Application Data
(60) Provisional application No. 61/570,546, filed on Dec. 14, 2011.

(51) Int. Cl. G21F 1/00

(52) U.S. Cl. CPC G21F 1/00
USPC 250/515.1

(57) ABSTRACT

A body shield (10) is disclosed for protecting a user from harmful thermal and electromagnetic radiation. The body shield includes a multi-layered core (11) which is surrounded by an outer casing (12). The multi-layered core includes a first layer (14) of a magnetic metal alloy for shielding extremely low frequency electromagnetic radiation, a second layer (15) of a carbon based material for absorbing higher frequency electromagnetic radiation, and a third layer (16) of a non-magnetic material for reflecting higher frequency electromagnetic radiation. The outer casing includes a thermal resistant top layer (18) and a thermal resistant bottom layer (19) sealed around its periphery to the top layer.

### REFERENCE TO RELATED APPLICATION

Applicant claims the benefit of U.S. Provisional Patent Application Ser. No. 61/570,546 filed Dec. 14, 2011.

### TECHNICAL FIELD

This invention relates to shields used to protect a person and devices from thermal and electromagnetic radiation, and particularly from harmful thermal and low to high electromagnetic radiation produced by electronic devices.

### BACKGROUND OF THE INVENTION

In today's society people are constantly coming into contact with harmful electromagnetic radiation from electronic devices such as laptop computers, cellular telephones, handheld tablet computers, handheld personal data devices (pda), and other electronic devices. The close proximity of these devices to the user exposes the person to an increase in excess levels of heat as well as low frequency to high frequency electromagnetic fields and radiations. This exposure to a person can cause serious medical issues.

As such, many devices are designed to include internal shields to reduce exposure to the user. These internal shields however are directional in nature and do not always provide adequate protection. Furthermore, these shields are typically designed to reduce one particular type of radiation and do not reduce a wide spectrum of radiations.

Accordingly, it is seen that a body shield that protects a user from different types of electromagnetic radiations associated with personal electronic devices is needed. It is to the provision of such therefore that the present invention is primarily directed.

### SUMMARY OF THE INVENTION

A body shield for shielding a person from thermal and electromagnetic radiation from portable electronic devices, the body shield comprises a core and an outer casing. The core includes a first layer having a material composition for shielding extremely low frequency electromagnetic radiation, a second layer having a material composition for absorbing high frequency electromagnetic radiation, and a third layer having a material composition for reflecting high frequency electromagnetic radiation. The outer casing has a generally thermal resistant material top layer overlaying the core and a generally thermal resistant material bottom layer underlying the core.

### BRIEF DESCRIPTION OF THE DRAWING

FIG. 1 is a perspective view of a body shield embodying principles of the invention in a preferred form.

FIG. 2 is an exploded view of the components of the body shield of FIG. 1.

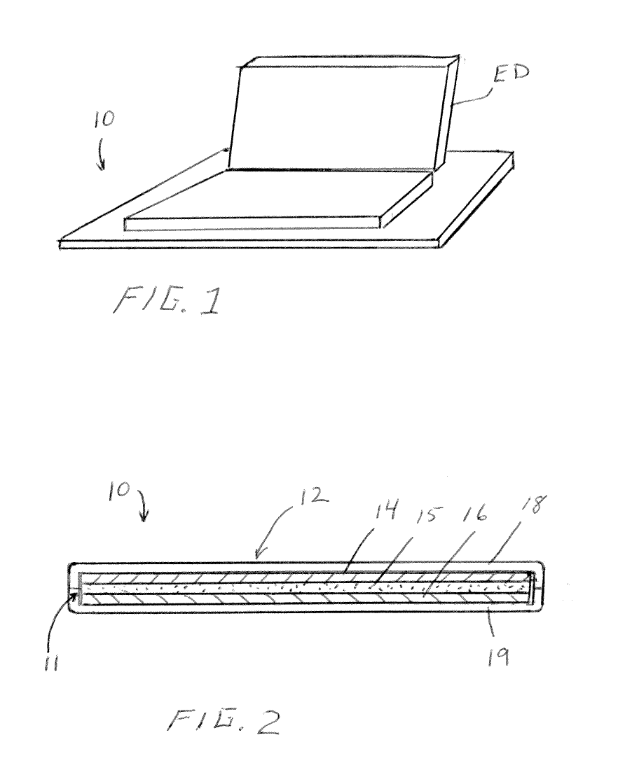

### DETAILED DESCRIPTION

With reference next to the drawing, there is shown a body shield 10 of the present invention in a preferred form. The body shield is designed to protect a user from harmful heat as well as low frequency to higher frequency electromagnetic fields and radiations, including radio frequency (RF) radiation, produced from portable electronic devices ED.

The body shield 10 includes a multi-layered core 11 which is encased within an outer casing 12. The multi-layered core 11 includes a first layer 14, a second layer 15, and a third layer 16. The core layers may be bonded together or be positioned one on top of the other and maintained in place by the outer casing. The outer casing 12 includes a top layer 18 and a bottom layer 19 sealed around its periphery to the top layer 18.

The first layer 14 is preferably made of a magnetic metal alloy comprised of at least 80 percent nickel and iron. Preferably, the material of the core first layer 14 is a mu-metal and is for shielding a user from extremely low frequency (ELF) electromagnetic radiation, i.e., it eliminates electromagnetic radiation in the range of 0 to 300 Htz. As such, it may be referred to as a magnetic field and radiation shielding having a very high permeability and very low coercive force, which supports the formation of a magnetic field within itself. This type of mu-metal material layer is sold by Carpenter Technology Corporation of Wyomissing, Pa., as part number 999-912 and referred to as Carpenter HyMu 80 Alloy. The first layer 14 has a preferred thickness of between 0.006 and 0.020 inches.

The core second layer 15 is preferably made of a carbon cloth or carbon fiber lamination medium and is for shielding a user from radio frequency (RE) or higher frequency electromagnetic radiation (EMR), i.e., it absorbs higher frequency electromagnetic radiation which is in the range of 800 Hz to 10 GHz with minimal reflection. As such, it may be referred to as a EMF shielding and conductive or absorbing fabric. This layer of material is also sold by Less EMF, Inc. Of Albany, N.Y. under the name Microwave Absorbing Sheet. The second layer 15 has a preferred thickness of between 0.020 and 0.125 inches. The carbon cloth may be comprised of random carbon fiber mesh, but may also be a weave, lamination, sheet or the like.

The core third layer 16 is preferably a non-magnetic, aluminum foil layer and is for shielding a user from radio frequency electromagnetic radiation. The third layer 16 is intended to reflect the radio frequency electromagnetic radiation (higher frequency electromagnetic radiation) in a direction back towards the second layer so that it may once again have the opportunity to be absorbed by the carbon cloth second layer. The third layer 16 has a preferred thickness of between 0.005 and 0.125 inches. As an alternative, other non-magnetic metal foil layers may be utilized such as copper, silver, etc.

The outer casing top layer 18 is preferably a plastic, generally thermal resistive, thermal resistant, heat resistant, or near non-thermal conducting material, these terms being interchangeably used herein, such as a polypropylene and is for shielding a user from heat produced by the electronic device positioned upon the top layer 18. The thermal non-conductive nature of the plastic is such that it reduces or eliminates the transfer of heat produced by the electronic device ED into the core and to the user. The top layer 18 has a preferred thickness of between 0.030 and 0.150 inches.

The outer casing bottom layer 19 is also preferably a plastic, generally non-thermal conducting material, such as polypropylene and is for further shielding a user from heat produced by the electronic device. Again, the thermal non-conductive nature of the plastic is such that it reduces or eliminates the transfer of heat produced by the electronic device ED from reaching the user. The bottom layer 18 has a preferred thickness of between 0.030 and 0.150 inches.

The bottom layer 19 may be joined to the top layer 18 through mechanical means (snap type fitment), adhesives, welds, or any other conventionally known manner of joining two layers. It is preferred that the top layer be softer than the bottom layer to reduce slippage of an electronic device positioned upon the body shield 10. Also, it is preferred that the bottom layer be stiffer that the top lay to provide a somewhat rigid support structure to the body shield.

In use, the body shield may be place on the user's lap or upon another structure such as a table and an electronic device is place upon the body shield top surface of the top layer 18. The heat and electromagnetic radiation emitted from the electronic device is either absorbed or reflected by the body shield so that it does not reach the user's body positioned below the body shield. The soft top layer helps to prevent the electronic device from slipping should the body shield be tilted or moved. Furthermore, the rigidity of the body shield aids in supporting the electronic device upon an uneven surface such as one's lap.

The present invention was tested for extremely low frequency electromagnetic radiation and radio frequency electromagnetic radiation shielding effectiveness. The test was conducted in a Lindgren modular shielded room measuring 24 feet by 10 feet by 10.5 feet and was lined with FT-100 ferrite panels, FAA-400 and EHP-18PCL Pyramid Absorbers. The chamber was verified to comply with the −0, +6 dB field uniformity requirement of IEC 61000-4-3. The shielding effectiveness is determined by commonly known standards. Since spectrum analyzers read power, shielding effectiveness is determined by the dB difference between the two shielded and unshielded power levels, read in dBm. The testing found that the extremely low frequency electromagnetic radiation shielding effectiveness at 300 Hz was approximately 98.25% while at 60 Hz is was approximately 95.16%. The testing also found that the radio frequency electromagnetic radiation shielding effectiveness was as follows: at a frequency of 800 MHZ the shielding effectiveness was −36.1 dB (horizontal) and −30.0 dB (vertical) resulting in a shielding effectiveness in percent as 99.97545% and 99.91872%, respectively; at a frequency of 1700 MHZ the shielding effectiveness was −34.9 dB (horizontal) and −26.1 dB (vertical) resulting in a shielding effectiveness in percent as 99.96764% and 99.75453%, respectively; at a frequency of 1900 MHZ the shielding effectiveness was −34.2 dB (horizontal) and −25.8 dB (vertical) resulting in a shielding effectiveness in percent as 99.961198% and 99.73697%, respectively; at a frequency of 2100 MHZ the shielding effectiveness was −33 dB (horizontal) and −24.5 dB (vertical) resulting in a shielding effectiveness in percent as 99.94988% and 99.64519%, respectively; and at a frequency of 5000 MHZ the shielding effectiveness was −28.9 dB (horizontal) and −21.1 dB (vertical) resulting in a shielding effectiveness in percent as 99.87118% and 99.22375%, respectively. This test data shows an extremely effective shielding of both low frequency and radio frequency electromagnet radiation.

It should be understood that the body shield may be of any size and shape. Typically, the body shield is configured to a given application, for example, if one desires a shield to protect themself from the thermal or electromagnetic radiation from a laptop computer the shield is configured to completely underlay such. By way of another example, if one desires to protect themself from the thermal or electromagnetic radiation from a cell phone the body shield would be made smaller to accommodate or better fit this particular use.

It should be understood that the body shield is lightweight and portable. Furthermore, the body shield provides a complete protection across a wide spectrum of the electromagnetic radiation field, including thermal radiation, extremely low frequency emissions (0 to 300 Hz), and higher frequency radiations (radio frequency (RF) electromagnetic radiation) in the range of 800 Hz to 10 GHz. The device may also be used to protect electronic devices from other electronic devices.

It should be understood that additional or multiple layers of the same or additional materials may be added to the body shield to provide additional protection. For example, a second non-magnetic aluminum foil layer may be positioned between the core first layer and the core second layer to provide additional higher frequency electromagnetic radiation reflecting capabilities prior to such reaching the second layer.

It thus is seen that a body shield is now provided that overcomes problems long associated with those of the prior art. Though the body shield has herein been shown in a preferred form, it may, or course, be used in other applications or in other configurations. It should be understood that many modifications, additions and deletions may be made to the preferred embodiment that has been illustrated and described without departure from the spirit and scope of the invention as set forth in the following claims.

1. A body shield for shielding a person from thermal and electromagnetic radiation from portable electronic devices, the body shield comprising,
a core including a first layer having a material composition for shielding extremely low frequency electromagnetic radiation, a second layer having a material composition for absorbing higher frequency electromagnetic radiation, and a third layer having a material composition for reflecting higher frequency electromagnetic radiation, and
an outer casing encasing said core, said outer casing having a generally thermal resistant material top layer overlaying said core and a generally thermal resistant material bottom layer underlying said core.

2. The body shield of claim 1 wherein said outer casing top layer is softer than said outer casing bottom layer.

3. The body shield of claim 1 wherein said outer casing bottom layer is stiffer than said outer casing top layer.

4. The body shield of claim 1 wherein said core first layer is a magnetic metal alloy.

5. The body shield of claim 4 wherein said core first layer magnetic metal alloy is at least 80 percent nickel and iron.

6. The body shield of claim 1 wherein said core second layer is a carbon based material.

7. The body shield of claim 6 wherein said core second layer carbon based material is a carbon fiber lamination.

8. The body shield of claim 1 wherein said core third layer is a non-magnetic metal foil.

9. The body shield of claim 8 wherein said core third layer non-magnetic metal foil is an aluminum foil.

10. The body shield of claim 1 wherein said core third layer reflects the higher frequency electromagnetic radiation in a direction back toward said core second layer

11. The body shield of claim 1 wherein said core first layer is a magnetic metal alloy, said core second layer is a carbon based material, and said core third layer is a non-magnetic metal foil.

12. A body shield for shielding a person from thermal and electromagnetic radiation from electronic devices, the body shield comprising,
a casing top layer;
a first electromagnetic shielding layer for shielding extremely low frequency electromagnetic radiation;
a second electromagnetic shielding layer for absorbing higher frequency electromagnetic radiation;
a third electromagnetic shielding layer for reflecting higher frequency electromagnetic radiation, and
a casing bottom layer.

13. The body shield of claim 12 wherein said third electromagnetic shielding layer is positioned over said bottom layer, said second electromagnetic shielding layer is positioned over said third electromagnetic shielding layer, said first electromagnetic shielding layer is positioned over said second electromagnetic shielding layer, and said top layer is positioned over said first electromagnetic shielding layer.

14. The body shield of claim 12 wherein said top layer is softer than said bottom layer.

15. The body shield of claim 12 wherein said bottom layer is stiffer than said top layer.

16. The body shield of claim 12 wherein said core first electromagnetic shielding layer is a magnetic metal alloy.

17. The body shield of claim 16 wherein said first electromagnetic shielding layer magnetic metal alloy is at least 80 percent nickel and iron.

18. The body shield of claim 12 wherein said second electromagnetic shielding layer is a carbon based material.

19. The body shield of claim 18 wherein said second electromagnetic shielding layer carbon based material is a carbon fiber lamination.

20. The body shield of claim 12 wherein said third electromagnetic shielding layer is a non-magnetic metal foil.

21. The body shield of claim 20 wherein said third electromagnetic shielding layer non-magnetic metal foil is an aluminum foil.

22. The body shield of claim 12 wherein said third electromagnetic shielding layer reflects the higher frequency electromagnetic radiation in a direction back toward said second layer

23. The body shield of claim 12 wherein said first electromagnetic shielding layer is a magnetic metal alloy, said second electromagnetic shielding layer is a carbon based material, and said third electromagnetic shielding layer is a non-magnetic metal foil.

24. The body shield of claim 12 wherein either said casing top layer or said casing bottom layer is made of a generally thermal resistant material.

25. The body shield of claim 12 wherein said casing top layer and said casing bottom layer are made of a generally thermal resistant material.
